(19) United States
(12) Patent Application Publication
(10) Pub. No.: US 2005/0217219 A1
(43) Pub. Date: Oct. 6, 2005

(54) Don't shoot! hunter orange safety collars for equines

(76) Inventors: Geraldine L. Stark, Brown City, MI (US); David L. Stark, Brown City, MI (US)

Correspondence Address: Geraldine L. Stark, 7561 Willis Road, Brown City, MI, 48416, US

(21) Appl. No.: 10/797,740

(22) Filed: Mar. 11, 2004

(51) Int. Cl. B68B 3/04

(52) U.S. Cl. 54/19.1

(57) ABSTRACT

The DON'T SHOOT! Collar is described where the collar consists of a double thickness of hunter orange material, sewn together which circles the neck of the equine and fastening together with two pieces of velcro. Each side of the collar has an optional/detachable jingle bell held to the collar with a lanyard hook, which attaches to a D-ring that is permanently Attached to the collar. The purpose of the collar is to allow the equine to be visible to the hunters Eyes and audible to the hunters ears. Thus helping to insure the safety of the horse and rider. The Responsible hunter will have early detection of the horse, which is not an animal intended to be hunted.

### CROSS-REFERENCE TO RELATED APPLICATIONS

U.S. Pat. No. 4,993,215 is a collar for a horse that pertains only to restraint. A way to secure the horse and prevent it from moving to another area.

Patent U.K. # GB 2153646 a is an attachment enabling dogs to be seen or identified in Conditions of poor weather and especially visibility at night.

Patent U.K # 2160405A is a device for canines and felines to be seen in conditions of poor visibility. The device has reflective material. The reflective material makes the Animal visible when exposed to headlights.

Patent # 2188524A This invention relates to a collar for animals such as dogs and Cats making them visible to a driver in night time driving. A reflective collar.

### STATEMENT REGARDING FEDERALLY SPONSORED RESEARCH OR DEVEOPMEMT

Not applicable

REFERENCE TO SEQUENCE LISTING, A TABLE, OR A COMPUTER DISC

Not applicable

### BACKGROUND OF INVENTION

Equines are in danger every time a hunting season opens. Many horses in the U.S. are injured or fatally wounded by gunshot during hunting season. The DON'T SHOOT! Collar is an easy way to attach hunter orange wear to your Equine, which will make them highly visible during hunting season. This will help prevent accidental injury or death to equine.

### BRIEF SUMMARY OF INVENTION

During hunting season the DON'T SHOOT! System will allow safety for equine and Rider while trail riding. Equines wearing DON'T SHOOT! Collars while grazing in the Pasture will be visible to hunters. There is history of equines and humans being injured or Fatally wounded in these instances. During hunting season the Collar will help keep both Rider and Equine safe. The jingle bells allow hunters audio perception of creatures in the Area not intended for hunting.

### BRIEF DESCRIPTION OF THE SEVERAL VIEWS OF THE DRAWING

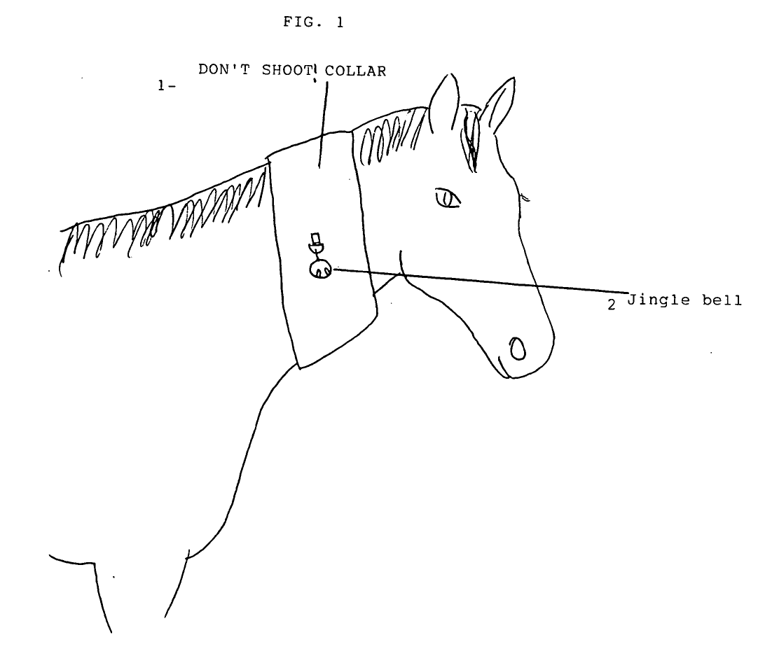

FIG. 1 DON'T SHOOT! Collar in place on equine
1-1 Collar
1-2 Jingle bell

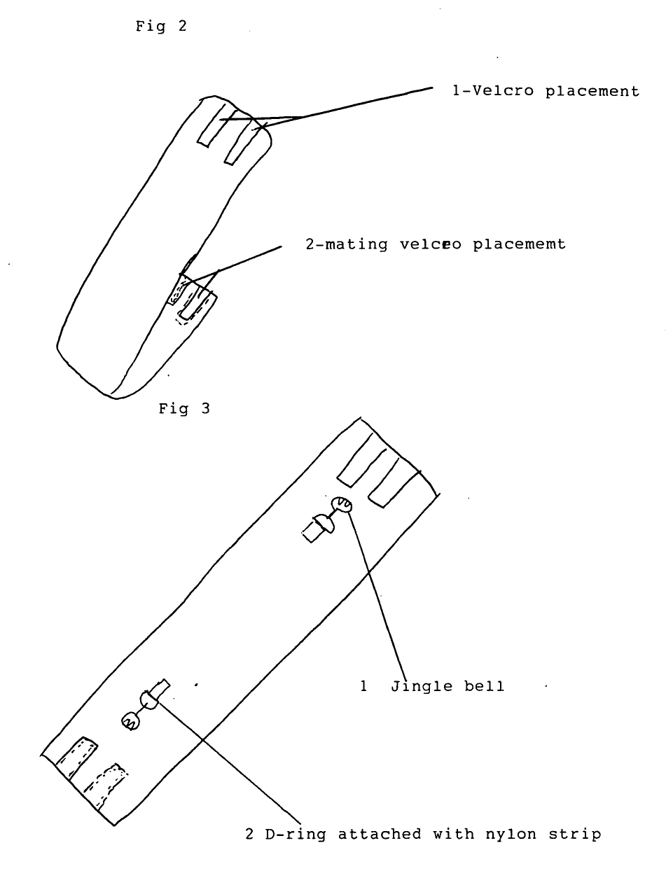

FIG. 2 DON'T SHOOT! Collar showing Velcro placement
2-1 Velcro placement
2-2 Mating Velcro placement

FIG. 3 DON'T SHOOT! Collar showing Velcro and jingle bell placement
3-1 Jingle bells
3-2 D-ring attached with nylon strip

### DETAILED DESCRIPTION OF THE INVENTION

The DON'T SHOOT! Collar is 30 to 82 inches long depending on type of equine. It is 10 inches wide. It is constructed of half polyester half cotton bright hunter orange material. It has two VELCRO(registered TradeMark) closures 2 inches wide and 8-10 inches long. The collar also has two optional/removable jingle bells. One bell on each side of collar Attached with lanyard hooks. The lanyard hooks attach to a half inch D-ring that is Permenantly sewed to the collar with half-inch wide nylon strap.

To construct Collar two pieces of hunter orange material is cut into 30 to 82 inches Long (depending on equine type) and 11 inches wide. They are place together with good Sides of material facing inward. Then stitched around edge of material with a half-inch Seam allowance, leaving one of the 11-inch ends partially unstitched. Allowing for the To be turned inside out and then press with iron. Press unstitched ends under to match Stitched areas. The stitch five-eights seam allowance around entire collar. At each end Sew the 8-10 inch velcro strips into place so they align and come into contact with mating Velcro when placed around equines neck. Then take half-inch nylon strip and cut each strip Two inches long (two strips total). Melt both ends of nylon with lighter to avoid unraveling. Fold nylon strips in half and pin one on each side of the collar (see drawing). Then stitch Into place. A jingle bell is then placed on a small lanyard and snapped to D-ring.

1) what we claim as our invention is a hunter orange equine collar that will help protect horse and rider from being injured or mortally wounded by gunshot during hunting season: The DON'T SHOOT! Collar will achieve this benefit by making wearer highly visible and not to be mistaken for an animal intended to be hunted.

2) What we claim as our invention is two audible jingle bells attached to the collar to Alert hunters in the area that there are living creatures and humans in area not intended to be hunted.

3) What we claim as our invention is a hunter orange collar that makes equines Visible if they are perhaps behind the animal intended to be hunted. Alerting hunters not to shot in that direction.

4) What we claim as our invention is the ability of the collar to break away from the Animal, if the animal were to become entangled, allowing the animal to escape Uninjured.
